(19) United States
(12) Patent Application Publication
(10) Pub. No.: US 2009/0023130 A1
(43) Pub. Date: Jan. 22, 2009

(54) Prevention of Transfusion Related Acute Lung Injury Using Riboflavin and Light

(75) Inventors: Raymond P. GOODRICH, Lakewood, CO (US); Suzanne MARSCHNER, Denver, CO (US)

Correspondence Address: CaridianBCT, Inc.;Mail Stop: 810 1F2, 10811 WEST COLLINS AVE, LAKEWOOD, CO, 80215, US

(73) Assignee: CARIDIANBCT BIOTECHNOLOGIES, LLC, Lakewood, CO (US)

(21) Appl. No.: 12/190,854

(22) Filed: Aug. 13, 2008

Related U.S. Application Data
(63) Continuation-in-part of application No. 10/377,524, filed on Feb. 28, 2003.
(60) Provisional application No. 60/957,382, filed on Aug. 22, 2007.

(51) Int. Cl. A01N 1/02

(52) U.S. Cl. 435/2

(57) ABSTRACT

This invention is directed toward a method of preventing the formation of bioactive substances in a pathogen inactivated blood component. The steps include illuminating the blood component with light at a sufficient energy so that an alloxazine photosensitizer present in the blood component may be photolyzed to inactivate any pathogens which may be present; preventing the formation of bioactive substances in the pathogen inactivated blood component; and storing the pathogen inactivated blood component.

### CROSS REFERENCE TO RELATED APPLICATIONS

This application claims benefit under 35 U.S.C. 119(e) of U.S. Provisional Application No. 60/957382, filed Aug. 22, 2007 and claims benefit under 35 U.S.C 120 of U.S. application Ser. No. 10/377524, filed Feb. 28, 2003.

### BACKGROUND

Contamination of blood supplies with infectious microorganisms such as HIV, hepatitis and other viruses and bacteria presents a serious health hazard for those who must receive transfusions of whole blood or administration of various blood components such as platelets, red cells, plasma, Factor VIII, plasminogen, fibronectin, anti-thrombin III, cryoprecipitate, human plasma protein fraction, albumin, immune serum globulin, prothrombin complex, plasma growth hormones, and other components isolated from blood. Blood screening procedures may miss contaminants, and sterilization procedures which do not damage cellular blood components but effectively inactivate all infectious viruses and other microorganisms have only recently been developed.

Photosensitizers, or compounds which absorb light of a defined wavelength and transfer the absorbed energy to an electron acceptor may be a solution to the above problems. Photosensitizers may be used to inactivate infectious microorganisms or other undesirable elements such as white blood cells which may be contaminating a blood product, without damaging the desirable components of blood.

There are many photosensitizer compounds known in the art to be useful for inactivating undesirable elements. Examples of such photosensitizers include porphyrins, psoralens, dyes such as neutral red, methylene blue, acridine, toluidines, flavine (acriflavine hydrochloride) and phenothiazine derivatives, coumarins, quinolones, quinones, anthroquinones and endogenous photosensitizers such as riboflavin.

Even after the blood or blood components have undergone a pathogen reduction procedure, there are still risks associated with blood transfusions. Transfusion-related acute lung injury (TRALI) is a rare but devastating complication of blood component therapy. Approximately 1 in 5000 transfusion patients will develop TRALI. Clinically, these patients present with findings similar to that of adult respiratory distress syndrome, consisting of hypotension, fever, dyspnea, and tachycardia. Noncardiogenic pulmonary edema with diffuse bilateral pulmonary infiltrates on chest radiography is characteristic. The onset typically occurs within 6 hours of transfusion, but most cases present within 1 to 2 hours. Transfusions of all blood products have been associated with the disease. TRALI is the second leading cause of mortality from transfusions.

It is to preventing the development of TRALI in patients receiving transfusions of blood or blood components that the present invention is directed.

### SUMMARY OF THE INVENTION

This invention is directed toward a method of preventing the formation of bioactive substances in a pathogen inactivated blood component. The steps include illuminating the blood component with light at a sufficient energy so that an alloxazine photosensitizer present in the blood component may be photolyzed to inactivate any pathogens which may be present; preventing the formation of bioactive substances in the pathogen inactivated blood component; and storing the pathogen inactivated blood component.

### BRIEF DESCRIPTION OF THE FIGURES

FIG. 1 is a schematic view of a set of bags which may be used with the process of the present invention.

FIG. 2 is a graph of in vitro neutrophil priming by supernatants from stored treated and untreated platelet units.

FIG. 3 is a graph of in vitro neutrophil priming by supernatants from stored treated and untreated packed red blood cells (pRBCs).

FIG. 4 is a table of proteins released into the supernatants of stored treated and untreated platelets.

FIG. 5 is a graph of an in vivo rat model of TRALI comparing the ability of supernatants of treated platelet concentrated (PCs) to induce ALI compared to supernatants of untreated controls.

### DETAILED DESCRIPTION

The pathophysiology of TRALI is not well understood. Two proposed mechanisms have been implicated in the development of transfusion-related ALI/ARDS (Adult Respiratory Distress Syndrome): (1) passive transfer of antileukocyte antibodies from alloimmunized donors (antibody mediated); and (2) biological response modifiers accumulated during the storage of cellular blood products (non-antibody mediated). In both mechanisms, activation of neutrophils plays a causal role, and these activated cells are thought to locally mediate pulmonary injury.

In the first proposed mechanism, leukocyte-activating donor antibodies present in the transfused blood component activate recipient leukocytes and complement, causing an inflammatory response in the lungs. Activated neutrophils attach to pulmonary endothelium with resultant injury and capillary leakage.

Typically leukocyte-activating donor antibodies are detected in the recipient's blood and are confirmed by corresponding leukocyte antigen typing or positive granulocyte crossmatch. To mediate the risk associated with this mechanism, the American Association of Blood Banks (AABB) has recommended reducing the use of plasma products from female donors.

The second proposed mechanism for the development of TRALI is an alternative two-event mechanism that does not implicate donor antibodies. In this model, the first event or “hit” is the development of an underlying condition in the patient that causes activation of the pulmonary endothelium leading to sequestration and priming of neutrophils and the second event or “hit” is the infusion (by transfusion) of biologically active substances which activate the neutrophils primed from the first “hit”.

The term “priming” refers to a heightened, but not full-blown stage of cellular activation. In the two-event model, neutrophil priming is induced by the first event. As applied to TRALI, the patients' initial underlying condition causes pulmonary endothelial cell activation, up-regulation of surface adhesion molecules, release of cytokines and recruitment of primed neutrophils. In this “primed state” transfusion of blood components (the second event) containing factors capable of inducing complete activation of the primed neutrophils in the lungs causes release of reactive oxygen species into the pulmonary vasculature. The resultant endothelial damage caused by the reactive oxygen leads to capillary leakage and pulmonary edema.

It is known that pathogen reduction procedures activate platelets. Activated platelets or pieces of platelets are believed to be a source of bioactive substances which induce complete activation of primed neutrophils. Lipids from cellular membranes have also been implicated as a source of bioactive substances. If these bioactive substances can be prevented from forming in the blood, the development of TRALI in a transfusion recipient could be prevented.

It would therefore be desirable if treatment of blood products before storage with a photosensitizer and light could induce changes in the blood/blood components during storage that might prevent bioactive substances in the blood from inducing complete activation of primed neutrophils.

A “photosensitizer” useful in this invention is defined as any compound which absorbs radiation at one or more defined wavelengths and subsequently utilizes the absorbed energy to carry out a chemical process.

Endogenous photosensitizers may be used in this invention. The term “endogenous” means naturally found in a human or mammalian body, either as a result of synthesis by the body or because of ingestion as an essential foodstuff (e.g. vitamins) or formation of metabolites and/or byproducts in vivo. When endogenous photosensitizers are used, particularly when such photosensitizers are not inherently toxic or do not yield toxic photoproducts after photoradiation, no removal or purification step is required after decontamination, and the decontaminated product can be directly administered to a patient.

Examples of such endogenous photosensitizers which may be used in this invention are alloxazines such as 7,8-dimethyl-10-ribityl isoalloxazine (riboflavin), 7,8,10-trimethylisoalloxazine (lumiflavin), 7,8-dimethylalloxazine (lumichrome), isoalloxazine-adenine dinucleotide (flavin adenine dinucleotide [FAD]) and alloxazine mononucleotide (also known as flavin mononucleotide [FMN] and riboflavin-5-phosphate). The term “alloxazine” includes isoalloxazines.

Use of endogenous isoalloxazines as photosensitizers to inactivate blood and blood components are described in U.S. Pat. Nos. 6,258,577 and 6,277,337 both issued to Goodrich et al., and herein incorporated by reference to the amount not inconsistent.

The amount of photosensitizer to be mixed with the blood components to be inactivated will be an amount sufficient to adequately inactivate any pathogen-associated nucleic acids which may be present in the fluid, but less than a toxic (to the blood components) or insoluble amount. If riboflavin is used as the photosensitizer, it may be added to the blood components at a final concentration of between about 50-500 μM.

A pathogen may be defined as any undesirable element found in blood, such as bacteria, virus and white blood cells. Pathogen-associated nucleic acid includes any undesirable nucleic acid such as nucleic acid contained in white blood cells, bacteria or viruses. Nucleic acids include either deoxyribonucleic acid (DNA), ribonucleic acid (RNA) or both.

The separated blood components to which the photosensitizer has been added is exposed to light of the appropriate wavelength to activate the photosensitizer and to substantially inactivate and cause permanent damage to the pathogen-associated nucleic acids. Substantially permanent damage means that the nucleic acids will not undergo self-repair or replication during storage or upon infusion into a donor, while maintaining the antigenic potential of the pathogen to be removed by the recipient's immune system.

It should be noted that in the drawings, like elements are represented by like numerals.

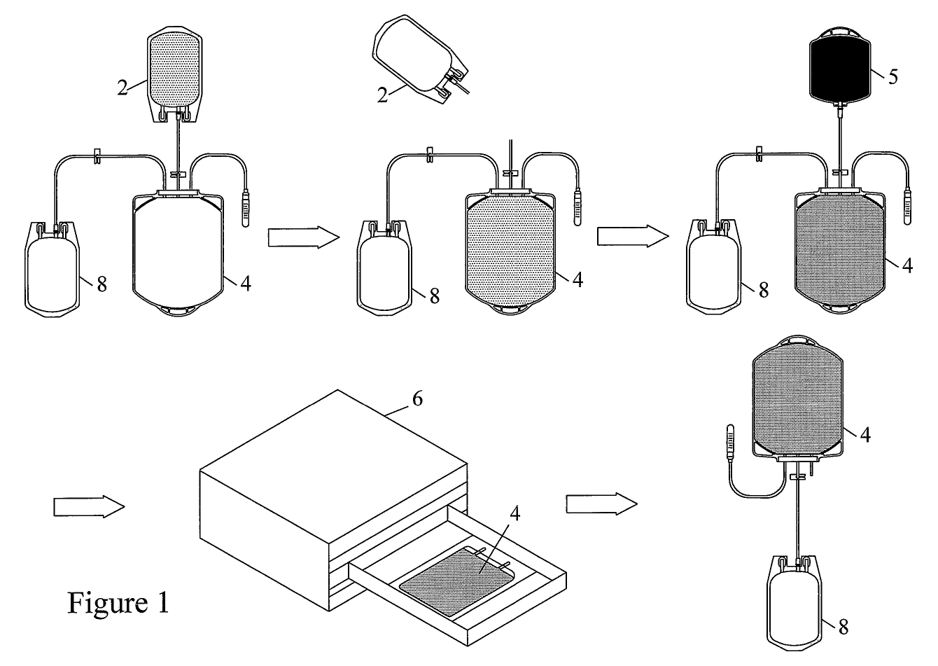

As shown in FIG. 1, separated blood components to be pathogen inactivated may be collected from a donor and separated into components by any method known in the art. The collected blood components in bag 2 can be transferred to a separate illumination bag 4, or can be illuminated directly in the component collection bag 2, depending upon the material of the collection bag. If illumination is to take place in the collection bag, the collection bag must be at least light permeable and of a size that permits mixing of the whole blood and photosensitizer during illumination. 35 mL of 500 μM riboflavin contained in a bag 5 is added to the blood components in bag 4, and the blood+riboflavin in bag 4 is illuminated in an illuminator 6 with around 6.24 J/mL of radiation. After illumination, the inactivated blood can be transferred to a storage bag 8 for later use or can be used immediately. The inactivated blood components can also be stored in the original collection container 2 or illumination bag 4 as well.

In the present invention, if the inactivated blood components are stored before use, any bioactive substances present in the blood components must not increase but rather decrease neutrophil priming in the recipient of the inactivated blood component(s). With the present invention, blood components do not need to be leukoreduced before the addition of photosensitizer, illumination and subsequent pathogen inactivation, nor do the separated pathogen reduced blood components need to be leukoreduced at any time before infusion into a recipient.

### Results

### EXAMPLE 1

In vitro Neutrophil Priming

This study evaluated the neutrophil priming capacity of supernatants from pathogen inactivated (treated) platelets stored in plasma for up to 7 days. The concentration of platelets ranged from 1180-2100×10⁶/ml in 420-730 ml of plasma. Both treated (riboflavin+light) and control (no riboflavin+light) samples were obtained by splitting a double-apheresis platelet product collected using standard apheresis techniques from a single donor (n=5). The treated samples were treated with riboflavin and 6.24 J/mLₚₗₐₜₑₗₑₜₛ UV light. Control samples were not pathogen inactivated and remained in the original component collection bag.

Neutrophils or PMNs were isolated from healthy donors by dextran sedimentation, ficoll-hypaque gradient centrifugation and hypotonic lysis of contaminating red blood cells. PMNs were warmed to 37° C., incubated with the plasma samples and fresh frozen plasma (FFP) (as a negative control) for 5 min and washed at 1,800 g for 3 min. The PMNs were resuspended in fresh, warm buffer and the maximal rate of superoxide anion production in response to fMLP (N-formyl-methionyl-leucyl-phenylalanine) was measured over time as the reduction of cytochrome c at 550 nm.

Neutrophil priming is defined as augmentation of the fMLP-activated respiratory burst after pre-incubation of the neutrophils with supernatant from stored platelets.

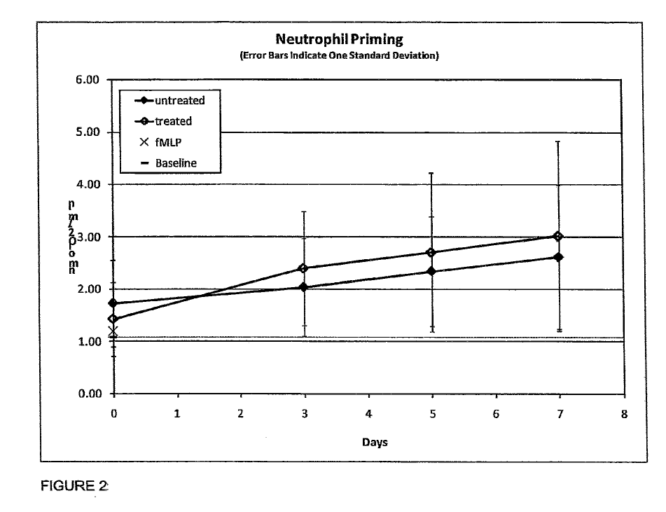

As can be seen in FIG. 2, no increased neutrophil priming was induced by supernatants from treated platelets (n=5) compared to untreated controls. The difference between treated and untreated units throughout storage was not statistically significant.

The neutrophil priming capacity of supernatants from treated red blood cells which have been stored in plasma over 42 days was also studied. 2 μM platelet activating factor (PAF), a known lipid priming agent, was added as a positive control to determine if it could inhibit the respiratory burst.

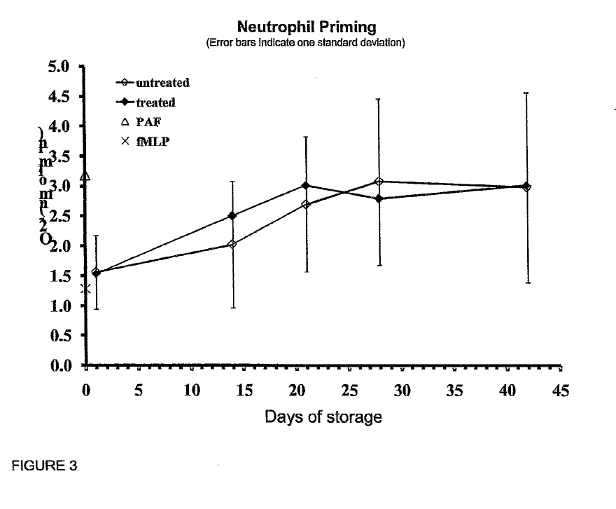

As can be seen in FIG. 3, no increased neutrophil priming was induced by supernatants from treated pRBCs (n=5) compared to untreated controls. The difference between treated and untreated units throughout 42 days of storage was not statistically significant.

### EXAMPLE 2

### Alpha-Degranulation

The following experiments were done to determine whether bioactive lipids which may prime neutrophils were generated during routine storage of platelets. The priming activity of lipid extracts were measured to ensure that treatment with riboflavin and light does not inhibit the respiratory burst.

The release of growth factors from the α-granules of platelets were measured using commercial ELISAs for selected growth factors (available from R&D Systems, Minneapolis, Minn., USA).

Platelet proteins stored in a-granules are released upon activation of the platelets and continues throughout the course of storage. VEGF (vascular endothelial growth factor), PDGF (platelet-derived growth factor), TGFβ1 (transforming growth factor) and FGF-2 (fibroblast growth factor) were measured in supernatants of stored platelets treated with riboflavin+light and untreated (no riboflavin+light) platelets.

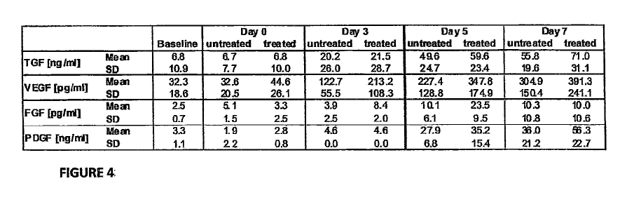

As seen in FIG. 4, after treatment with riboflavin and light the amount of released proteins in the supernatant of stored platelets increased as compared to untreated controls, but differences were not statistically significant. FGF binds to activated platelet membranes so the observed decrease on day 7 may be due to bound FGF not captured in the assay.

### EXAMPLE 3

In vivo ALI (Acute Lung Injury) in Rats

This experiment measured the ability of supernatants of treated platelet concentrated (PCs) to induce ALI compared to supernatants of untreated controls.

To measure TRALI in vivo, male Sprague Dawley rats were used as the model. The rats were weighed and injected with 2 mg/kg of LPS (S. enteritides, available from Sigma-Aldrich, St. Louis, Mo., USA) or pyrogen-free saline for injection (USP, available from Baxter, USA) IP and incubated for 2 hours (the first event or “hit). Following the 2 hr incubation the rats were anesthetized with 50 mg/kg pentobarbital. The airway is cleaned: debris removed by forceps and the oral cavity and pharynx were suctioned. The leg was shaved and the rat is secured with string around the extremities. The skin was anesthetized with lidocaine and a cut-down is performed to cannulate the femoral vessels using PE50 tubing (available from Fisher Scientific, Houston, Tex., USA) sutured in with 4.0 silk. The temperature was monitored and the airway checked to ensure it remained clear. An arterial line was connected to a ProPac™ manometer to measure blood pressure. The arterial line was heparinized by injecting 0.1 ml of 10,000 units/ml of sodium heparin and 5-10% of the rat's blood volume (blood volume=60× body weight in kg (28)) was removed over 20-30 min. To induce the second event or “hit”, an equal amount of saline, followed by heat-treated plasma from stored or fresh blood products was infused over 30 min and monitored every 10 min. Following transfusion of the second “hit” or saline, Evans Blue dye [10 mg/ml stock] was injected at a dose of 30 mg/kg over 15 min and the catheters were “cleared” with 0.1 ml of sodium heparin. The rat was placed back into its cage in a prone position on clean 4×4 gauze pads and incubated for 6 hours. The rats were monitored every 30 min if asleep; especially the airway, and the catheters were kept free of blood. Following incubation the rats were anesthetized (pentobarbital 25 mg/kg IV); and 3 ml of blood was obtained from the indwelling catheter and stored at 4° C. The rat was euthanized with pentobarbital (100 mg/kg) and a tracheotomy was performed followed by a bronchoalveolar lavage (BAL) with 5 ml of saline and 3 washes of the lung (all rats receive an identical amount of saline for the BAL). Following the BAL the lungs were removed and weighed. Both BAL fluids and the heparinized blood were centrifuged at 5,000 g for 10 min to remove any kind of cells and cellular debris. Extra plasma and BAL fluid were stored at −80° C. and 200 μl of plasma and 400 μl are used to measure Evens Blue dye (EBD) lung leak from the circulation (% EBD in the plasma), using a standard curve & linear regression at 620 nm, zero at 740 nm.

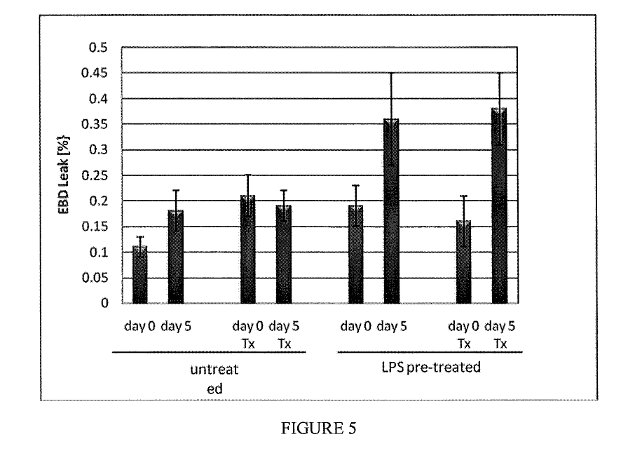

FIG. 5 shows that a two-event, in vivo rat model of TRALI demonstrated no injury when saline (untreated) was used as the first event followed by heat-treated plasma (56° C. for 30 min to destroy the effects of human complement and fibrinogen) as the second event for plasma from day 0 or day 5 platelets. Furthermore, when LPS was given as the first event followed by heat-treated plasma from day 0 or day 5, day 0 plasma did not cause acute lung injury (ALI), and day 5 only elicited mild injury. Treatment with riboflavin and light did not further enhance or decrease ALI in this two-event in vivo model.

Although treatment with riboflavin and light causes platelet activation, as shown in FIG. 5 by increased α-degranulation, no increased neutrophil priming or in vivo ALI induction could be detected in vivo after treatment with riboflavin+light.

1. A method of preventing the formation of bioactive substances in pathogen inactivated blood or blood component comprising the steps of;
illuminating the blood or blood component with light at a sufficient energy so that an alloxazine photosensitizer present in the blood or blood component may be photolyzed to inactivate any pathogens which may be present;
preventing the formation of bioactive substances in the pathogen inactivated blood or blood component; and
storing the pathogen inactivated blood or blood component.

2. The method of claim 1 wherein the alloxazine photosensitizer is riboflavin.

3. The method of claim 1 wherein the energy sufficient to photolyze the alloxazine photosensitizer in the blood or blood component is about 6.24 J/mL.

4. The method of claim 1 wherein the step of preventing the formation of bioactive substances further comprises the step of not increasing neutrophil priming in a recipient of the pathogen inactivated blood or blood component.

5. The method of claim 1 wherein the blood component is platelets.

6. The method of claim 1 wherein the blood component is red blood cells.

7. The method of claim 1 wherein the blood component is plasma.
